(19) United States
(12) Patent Application Publication
(10) Pub. No.: US 2006/0096474 A1
(43) Pub. Date: May 11, 2006

(54) Method of calculating stencil material roll residue, stencil making system and stencil material roll

(76) Inventors: Manabu Iwamoto, Ibaraki-ken (JP); Kenji Oshima, Ibaraki-ken (JP)

Correspondence Address: Matthew K. Ryan;Frommer Lawrence & Haug, 745 Fifth Avenue, New York, NY, 10151, US

(21) Appl. No.: 10/537,970

(22) PCT Filed: Dec. 4, 2003
(86) PCT No.: PCT/JP03/15552

§ 371 Date: Jun. 9, 2005

(30) Foreign Application Priority Data
Dec. 10, 2002 (JP) 2002-357467

(51) Int. Cl. B41C 1/14

(52) U.S. Cl. 101/128.4

(57) ABSTRACT

To more accurately calculate a stencil material roll residue in a stencil making system where stencil material unrolled from a stencil material roll is perforated and cut to make a plurality of kinds of stencils having different lengths. The stencil material roll residue is calculated by storing in a first storage means (70) a total length of the stencil material roll before use, storing in the storage portions (90) respectively provided on a plurality of kinds of the printing drums (31) length of a plurality of kinds of stencils to be wound around the printing drums (31) and a residue calculating means (65) reading out the lengths of the stencils which have been made from the storage portions (90) of the printing drums (31) and cumulatively subtracting the lengths of the stencils from the total length of the stencil material roll read out from the first storage means (70).

### BACKGROUND OF THE INVENTION

1. Technical Field

This invention relates to a stencil making system where stencil material unrolled from a stencil material roll is perforated and cut to make a plurality of kinds of stencils having different lengths, a method of calculating a stencil material roll residue employed in the system and a stencil material roll employed to carry out the method.

2. Background Art

There have been proposed various stencil printers where a stencil material is perforated, by driving, for instance, a thermal head on the basis of image data read by a scanner or the like and is subsequently cut to make a stencil, the stencil is wound around a printing drum, and ink is supplied inside the printing drum to be transferred to a printing paper through the stencil by, for instance, a roller, thereby making print.

In the above-mentioned stencil printer, for instance, a stencil material roll is unrolled to feed stencil material by a length corresponding to one stencil and the unrolled stencil material is perforated and cut from the stencil material roll, whereby a stencil is made. Stencil printing can be repeatedly made by changing the stencil material roll for a new one after making a plurality of stencils.

When repeatedly making stencil printing in the above-mentioned stencil printer, there are sometimes cases where the operator wants to know the stencil material roll residue. Further, when the stencil material roll residue becomes shorter than the length corresponding to one stencil, it is necessary to change the stencil material roll for a new one. For this purpose, there is proposed in Japanese Unexamined Patent Publication No. 2001-18507 a method in which the total length of a stencil material roll before use is stored in a storage means such as a memory in a stencil material roll and a length of the stencil is subtracted from the total length of a stencil material roll each time a stencil is made, thereby calculating the stencil material roll residue.

However, the method of calculating a stencil material roll residue disclosed in Japanese Unexamined Patent Publication No. 2001-18507 is disadvantageous in that since the length corresponding to one stencil to be subtracted from the total length of the stencil material roll in the method is a constant value which is set from the printer to printer, the stencil material roll residue cannot be accurate in a stencil printer which is provided with a plurality of printing drums which conform to the sizes of print to be made and in which a printing drum suitable to the size of print to be made is used since the lengths of the stencils made in such a stencil printer are not always equal to the constant value.

### DISCLOSURE OF THE INVENTION

In view of the foregoing observations and description, the primary object of the present invention is to provide a method of calculating a stencil material roll residue and a stencil making system which can more accurately calculate the stencil material roll residue in a stencil making system where stencil material unrolled from a stencil material roll is perforated and cut to make a plurality of kinds of stencils having different lengths, and a stencil material roll employed to carry out the method.

In accordance with an aspect of the present invention, there is provided a method of calculating a stencil material roll residue for use in a stencil making system where stencil material unrolled from a stencil material roll is perforated and cut to make a plurality of kinds of stencils having different lengths, which method comprises the steps of

storing a total length of the stencil material roll before use and lengths of a plurality of kinds of stencils which the stencil making system can make and

selecting a length of the stencil made from the lengths of the plurality of kinds of stencils stored and subtracting the length from the total length of the stencil material roll.

In accordance with another aspect of the present invention, there is provided a stencil making system where stencil material unrolled from a stencil material roll is perforated and cut to make a plurality of kinds of stencils having different lengths, which system is characterized by

a first storage means which stores a total length of the stencil material roll before use,

a second storage means which stores lengths of a plurality of kinds of stencils which the stencil making system can make, and

a residue calculating means which calculates a stencil material roll residue in the stencil making system by reading out from the second storage means the lengths of the stencils which have been made and cumulatively subtracting the lengths of the stencils from the total length of the stencil material roll stored in the first storage means.

The “total length of the stencil material roll” means the overall length of the stencil material in the stencil material roll.

The “lengths of a plurality of kinds of stencils” means the length of one stencil of each of the stencils standardized, for instance, by an A3 length, a B4 length or an A4 length.

In the residue calculating means, the residue of the stencil material roll may be calculated either each time a stencil is made, or, as requested, for instance when the stencil material roll residue is to be displayed, by storing a length read out from the second storage means or a sum of lengths read out from the second storage means as consumption and subtracting the stored length from the total length when requested. The consumption may be stored in the first storage means.

The first storage means may be provided on the stencil material roll.

The stencil making system may further comprise a plurality of kinds of printing drums which conform to respective lengths of a plurality of stencils and around which stencils conforming to the respective printing drums in length are wound, wherein the second storage means stores the kinds of the printing drums linked with lengths of the respective stencils to be wound around the printing drums, and the residue calculating means reads out the lengths of the stencils which have been made by detecting the kinds of the printing drums around which the stencils which have been made were wound and reading out from the second storage means lengths of the stencils corresponding to the printing drums detected.

The stencil making system may further comprise a plurality of kinds of printing drums which conform to respective lengths of a plurality of stencils and around which stencils conforming to the respective printing drums in length are wound, wherein the second storage means comprises a plurality of storage portions each of which is provided on each of the printing drums to store the length of the stencil to be wound around the printing drum, and the residue calculating means reads out the lengths of the stencils which have been made by reading out length of the stencil stored by the storage portion provided on the printing drum around which the stencil which has been made is wound.

The stencil making system may further comprise a display means which displays the number of stencils which can be further made on the basis of the stencil material roll residue calculated by the residue calculating means.

In accordance with still another aspect of the present invention, there is provided a stencil material roll which is for carrying out the method of calculating a stencil material roll residue defined in Claim 1 and comprises a storage means which stores a total length of the stencil material roll before use.

In the stencil material roll, the storage means may store a stencil material roll residue which is obtained by cumulatively subtracting the lengths of the stencils which have been made from the total length of the stencil material roll.

Further, the storage means may store the sum of the lengths of the stencils which have been made, to be cumulatively subtracted from the total length of the stencil material roll.

In accordance with the method of calculating a stencil material roll residue and a stencil making system of the present invention, a total length of the stencil material roll before use is stored in a first storage means while lengths of a plurality of kinds of stencils are stored in the second storage means and the lengths of the stencils which have been made are read out from the second storage means to be cumulatively subtracted from the total length of the stencil material roll, whereby a stencil material roll residue is calculated. Accordingly, an accurate length of the stencils which have been made can be read and subtracted and the stencil material roll residue can be more accurate.

When the first storage means which stores a total length of the stencil material roll before use is provided on the stencil material roll in the stencil making system, the stencil material roll residue can be calculated more accurately irrespectively of the total length of the stencil material roll installed in the stencil making system. When also the stencil material roll residue is stored in the first storage means, the stencil material roll residue can be calculated more accurately even if a partly used stencil material roll from which one or more stencils have been made to remain a stencil material from which one or more stencils can be made is installed.

When the stencil material roll is calculated by detecting the kind of the printing drum around which the stencil made is wound and cumulatively subtracting the length of the stencil corresponding to the kind of the detected printing drum from the total length of the stencil material roll, the length of the stencil to be subtracted from the total length of the stencil material roll can be automatically determined upon detection of the kind of the detected printing drum. Further, the stencil material roll residue can be more accurately calculated irrespective of the kind of the printing drum to be installed.

When the stencil making system further comprises a display means which displays the number of stencils which can be further made on the basis of the stencil material roll residue calculated by the residue calculating means, information which is easier for the operator to understand as compared with when the stencil material roll residue is displayed in a length or a percentage can be provided.

In accordance with the stencil material roll of the present invention, since the stencil material roll has a storage means which stores a total length of the stencil material roll before use, the total length of the stencil material roll can be automatically obtained even if a stencil material roll the total length of which is not known to the operator is installed.

Further, when the storage means stores the stencil material roll residue, the stencil material roll residue at that time can be automatically obtained even when a partly used stencil material roll is installed and can be accurately calculated after installation thereof.

Further when the storage means stores the sum of the lengths of the stencils which have been made as consumption, the stencil material roll residue can be automatically obtained by subtracting the consumption from the total length of the stencil material roll. Further, the stencil material roll residue can accurately calculated even when a partly used stencil material roll is installed.

### BRIEF DESCRIPTION OF THE DRAWINGS

FIG. 1 is a view showing in brief a stencil printer employing a stencil making system in accordance with an embodiment of the present invention, and

FIG. 2 is a block diagram showing a part of the stencil printer shown in FIG. 1.

### BEST MODE FOR CARRYING OUT THE INVENTION

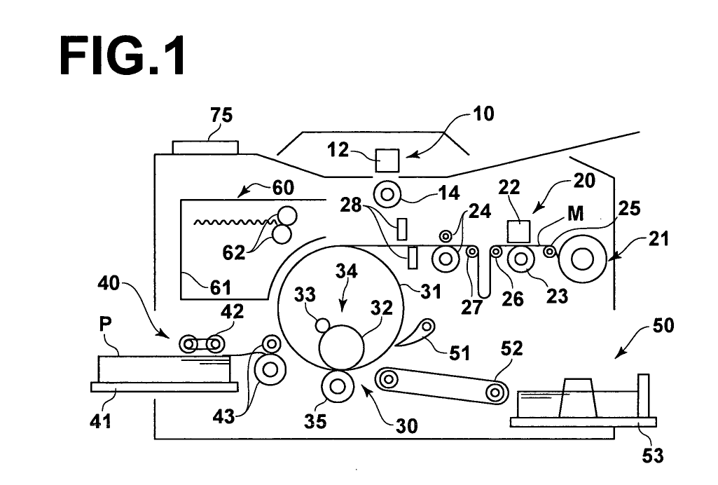

A stencil printer employing a stencil making system in accordance with an embodiment of the present invention will be described with reference to the drawings, hereinbelow. FIG. 1 is a view showing in brief the stencil printer of this example.

As shown in FIG. 1, the stencil printer comprises a reading portion 10 which reads out an image on an original, a stencil making portion 20 which makes a stencil from stencil material on the basis of the image information read by the reading portion 10, a printing portion 30 which prints on a printing paper by the use of the stencil M made by the stencil making portion 20, a paper supply portion 40 which supplies the printing paper to the printing portion 30, a paper discharge portion 50 which discharges the printed printing paper from the printing portion 30, and a stencil discharge portion 60 which discharges the stencil M after use.

The image read-out portion 10 is an image scanner and comprises an image line sensor 12 which reads out an image on an original conveyed in a sub-scanning direction, and original feed rollers 14.

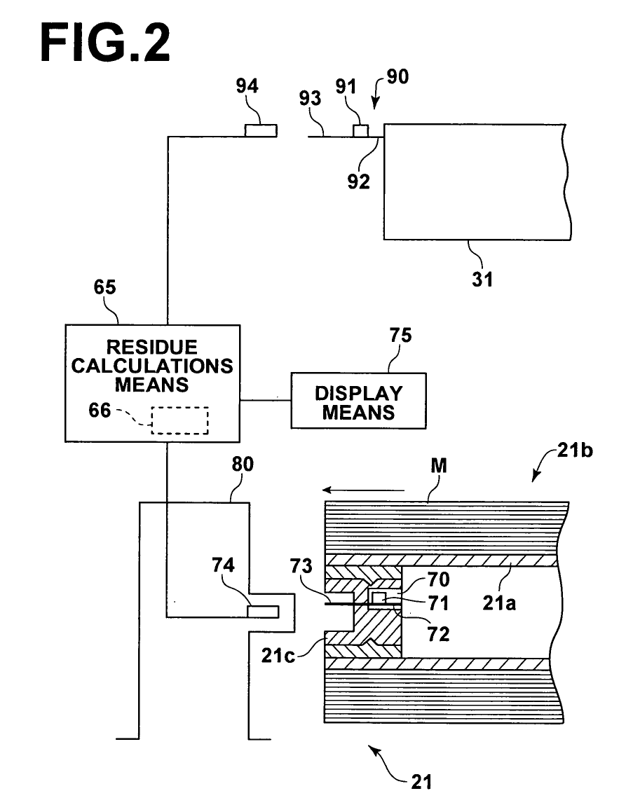

The stencil making portion 20 comprises a stencil material roll portion 21, a stencil making unit 22 having a thermal head where plurality of heater elements are arranged in a row, stencil material rollers 23 and 24, a roller motor 24 which rotates the platen roller 23, stencil material guide rollers 25, 26 and 27, and a stencil cutter 28. As shown in FIG. 2, in the stencil material roll portion 21, a stencil material roll 21b comprising stencil material M wound around a paper core 21a is mounted on a master holder 80 to be changeable. A first storage means 70 which stores each of a total length of the stencil material roll 21b before use and the residue of the stencil material M after use of the stencil material roll 21b as a length is disposed in a support member 21c mounted for rotation on one end portion of the paper core 21a. The first storage means 70 comprises a memory IC 71 forming a non-volatile memory (e.g., an EEPROM) which can hold data for a predetermined time without power supply, and a contact 73 is provided on the tip of a board 72 on which the memory IC 71 is mounted. Further, as shown in FIG. 2, a connector 74 to be electrically connected to the contact 73 of the first storage means 70 of the stencil material roll 21b is disposed in the master holder 80. The connector 74 functions as a part of a residue calculating means 65 to be described later.

The stencil material M unrolled from the stencil material roll 21b is thermally perforated by selectively energizing the heater elements of the thermal head of the stencil making unit 22 and is cut by the stencil cutter 28 into a stencil.

The printing portion 30 comprises a cylindrical ink-transmittable printing drum 31 which is formed of a porous metal plate or a mesh structure, an ink supply system 34 having a squeegee roller 32, and a doctor roller 33 which are disposed inside the printing drum 31, and a press roller 35. The stencil is wound around outer periphery of the printing drum 31. In the printing portion 30 of the stencil printer of this embodiment, a plurality of kinds of printing drums 31 respectively conforming to the lengths of a plurality of kinds of stencils, for instance, an A3 length, a B4 length or an A4 length are mounted to be changeable. A storage portion 90 which stores the lengths of the stencils according to the kind of the printing drum 31 is disposed in one end portion of the printing drum 31. The storage portion 90 comprises a memory IC 91 forming a non-volatile memory (e.g., an EEPROM) which can hold data for a predetermined time without power supply, and a contact 93 is provided on the tip of a board 92 on which the memory IC 91 is mounted. Further, as shown in FIG. 2, a connector 94 to be electrically connected to the contact 93 of the storage portion 90 is disposed in the stencil printer of this embodiment. The connector 94 functions as a part of the residue calculating means 65 to be described later.

The paper supply portion 40 comprises a paper supply table 41 on which printing papers P are stacked, a pick-up roller 42 which takes out the printing papers P one by one from the paper supply table 41, and a pair of timing rollers 43 which sends a printing paper P between the printing drum 31 and the press roller 35.

The paper discharge portion 50 comprises a separator 51 which peels off printing paper P from the printing drum 31, a paper discharge belt portion 52, and a paper discharge table 53 on which the printed printing papers P are stacked.

The stencil discharge portion 60 comprises a stencil discharge box 61 which is disposed on one side of the printing portion 30 and in which the stencil M peeled off the printing drum 31 is placed, and a pair of stencil discharge rollers 62 which peel the stencil M off the printing drum 31 after use and convey the stencil M peeled off the printing drum 31 into the stencil discharge box 61.

Further, the stencil printer of this embodiment is provided with the residue calculating means 65 which calculates the residue of the stencil material roll 21b by cumulatively subtracting the length of the stencil from the total length of the stencil material roll 21b each time a stencil is made and a display means 75 which displays the stencil material roll residue calculated by the residue calculating means 65. The display means 75 comprises a liquid crystal panel and is provided on the upper surface of the stencil printer as shown in FIG. 1.

Operation of the stencil printer of this embodiment will be described, hereinbelow.

One of the plurality of kinds of printing drums is selected to be installed by the operator, whereby the connector 94 is electrically connected to the contact 93 of the storage portion 90 provided in the printing drum 31 and the length of the stencil which is stored in the storage portion 90 according to the kind of the printing drum 31 is read out by the residue calculating means 65 and is stored in a memory 66 provided in the residue calculating means 65. On the other hand, the stencil material roll 21b is installed on the master holder 80 and the connector 74 on the master holder 80 is electrically connected to the contact 73 of the first storage means 70 provided on the stencil material roll 21b, whereby the total length of the stencil material roll 21b before use which is stored in the first storage means 71 is read out by the residue calculating means 65 and is stored in a memory 66 provided in the residue calculating means 65. Then the stencil material M is fed in a length equal to the length of the stencil stored in the storage means 90 and is perforated in the stencil making portion 20 and is cut by the stencil cutter 28 into a stencil. The stencil is wound around the printing drum 31. Ink in a predetermined color is supplied inside the printing drum 31 by the ink supply system 34. As the printing drum is rotated in the counterclockwise direction as seen in FIG. 1, a printing paper P is moved left to right as seen in FIG. 1 by the timing rollers 43 to be supplied between the printing drum 31 and the press roller 35 at a predetermined timing in synchronization with the rotation of the printing drum 31. The printing paper P is subsequently pressed by the press roller 35 against the stencil M on the outer peripheral surface of the printing drum 31, whereby the printing paper P is printed with the ink in the predetermined color.

Together with the stencil making action and the stencil printing action described above, the length of the stencil which has been stored in the memory 66 is subtracted from the total length of the stencil material roll 21b before use which has been stored in the memory 66 in the residue calculating means 65 and the value obtained is stored again in the memory 66 as the residue of the stencil material roll 21b. The residue of the stencil material roll 21b stored in the memory 66 is stored in the first storage means 70 by way of the connector 74 and the contact 73. Further, the residue calculating means 65 divides the residue of the stencil material roll 21b which has been stored in the first storage means 70 by the length of the stencil to calculate the number of stencils which can be further made, and output the number to the display means 75. The display means 75 displays the number on the liquid crystal panel.

When the next stencil making is begun, the residue calculating means 65 reads out again the length of the stencil stored in the storage portion 90 of the printing drum 31 and subtracts the length of the stencil from the residue of the stencil material roll 21b stored in the memory 66 to store again the value obtained in the memory 66. The residue of the stencil material roll 21b stored in the memory 66 is stored again in the first storage means 70 by way of the connector 74 and the contact 73. Further, the residue calculating means 65 calculates the number of stencils which can be further made in the same manner as described above, and output the number to the display means 75. The display means 75 updates the number of stencils which can be further made and displays the number on the liquid crystal panel. When the printing drum 31 is changed for another kind of printing drum 31, the residue calculating means 65 subtracts the length of stencil stored in the storage means 90 of the new printing drum 31 from the stencil material roll residue stored in the memory 66 of the residue calculating means 65. Then the residue calculating means 65 calculates the number of stencils which can be further made on the basis of the length of stencil stored in the storage means 90 of the new printing drum 31 and causes the display means 75 to display the number.

Further, when the stencil material roll 21b installed on the master holder 80 is partly used, the residue calculating means 65 reads out the residue stored in the first storage means 70 of the stencil material roll 21b and subtracts the length of stencil stored in the memory 66 from the residue read out, thereby calculating the residue.

Though the total length of the stencil material roll 21b before use or the residue of the stencil material roll 21b calculated by cumulatively subtracting the lengths of the stencil is stored in the memory 66 of the residue calculating means 65 or the first storage means 70 of the stencil material roll 21b, the memory 66 of the residue calculating means 65 or the first storage means 70 of the stencil material roll 21b may either update and store the total length or the residue of the stencil material roll 21b each time the total length or the residue is calculated or store all the total lengths or the residues of the stencil material roll 21b calculated.

In accordance with the stencil printer described above, a total length of the stencil material roll 21b before use is stored in the first storage means 70 while lengths of a plurality of kinds of stencils are stored in the storage portion 90 and the lengths of the stencils which have been made are read out from the storage portion 90 to be cumulatively subtracted from the total length of the stencil material roll, whereby the residue of a stencil material roll 21b is calculated. Accordingly, an accurate length of the stencils which have been made can be read and subtracted and the residue of the stencil material roll 21b can be more accurate.

Further, though in the stencil printer described above, the length of stencil is stored in the storage portion 90 provided in the printing drum 31, various variations are conceivable so long as the length of stencil conforming to the printing drum 31 can be known. For example, by storing the kind of the printing drum in the storage portion 90 of the printing drum 31 while providing a lookup table representing the relation between the kind of the drum and the length of stencil in the residue calculating means 65, the residue calculating means 65 may read out the kind of the printing drum to obtain the length of stencil corresponding to the kind of the printing drum according to the lookup table and calculate the stencil material roll residue by cumulatively subtracting the length of stencil obtained from the total length of the stencil material roll. Further, a bar code representing the kind of the printing drum may be provided on the printing drum 31 so that the residue calculating means 65 reads out the bar code to obtain the length of stencil corresponding to the kind of the printing drum according to the lookup table in the same manner as described above and calculates the stencil material roll residue.

Further, information on the length of stencil need not be provided on the printing drum 31, it is possible to obtain the length of stencil corresponding to the kind of the length of stencil (e.g., A3, B4 or A4) input by the operator through a predetermined input means such as a keyboard or a touch panel.

The mechanism for reading out the total length of the stencil material M or the residue of the stencil material M from the first storage means 70 on the stencil material roll 21b or the storage portion 90 on the printing drum 31 need not comprise a mechanism for electrically connecting a contact 73 or 93 and a connector 74 or 94 as described above, but may comprise other mechanisms. A wireless mechanism such as those using infrared rays may be employed to read out the total length or the stencil material roll residue.

Further, an alarm lamp may be lit, a message may be displayed by, for instance, the display means 75 or an alarm sound may be made when the residue calculated by the residue calculating means 65 becomes smaller than a predetermined value.

In the stencil printer in accordance with the embodiment described above, a sensor which detects whether the stencil material M is normally cut after perforated is sometimes provided and when the sensor detects that the stencil material M is not normally cut, the printing drum 31 is sometimes rotated several times and the stencil making processing is sometimes done again. In this case, the length of the stencil material M consumed by the several rotations of the printing drum 31 is subtracted to calculate the residue of the stencil material roll 21b.

1-9. (canceled)

10. A stencil making system where stencil material unrolled from a stencil material roll is perforated and cut to make a plurality of kinds of stencils having different lengths, which system is characterized by
a first storage means which stores a total length of the stencil material roll before use,
a second storage means which stores lengths of a plurality of kinds of stencils which the stencil making system can make, and
a residue calculating means which calculates a stencil material roll residue in the stencil making system by reading out from the second storage means the lengths of the stencils which have been made and cumulatively subtracting the lengths of the stencils from the total length of the stencil material roll stored in the first storage means.

11. A stencil making system as defined in claim 10 in which said first storage means is provided on the stencil material roll.

12. A stencil making system as defined in claim 11 further comprising a plurality of kinds of printing drums which conform to respective lengths of a plurality of stencils and around which stencils conforming to the respective printing drums in length are wound,
wherein the second storage means stores the kinds of the printing drums linked with lengths of the respective stencils to be wound around the printing drums, and
the residue calculating means reads out the lengths of the stencils which have been made by detecting the kinds of the printing drums around which the stencils which have been made were wound and reading out from the second storage means lengths of the stencils corresponding to the printing drums detected.

13. A stencil making system as defined in claim 11 further comprising a plurality of kinds of printing rums which conform to respective lengths

14. A stencil making system as defined in claim 10
further comprising a plurality of kinds of printing drums which conform to respective lengths of a plurality of stencils and around which stencils conforming to the respective printing drums in length are wound,
wherein the second storage means comprises a plurality of storage portions each of which is provided on each of the printing drums to store the length of the stencil to be wound around the printing drum, and
the residue calculating means reads out the lengths of the stencils which have been made by reading out length of the stencil stored by the storage portion provided on the printing drum around which the stencil which has been made is wound.

15. A stencil making system as defined in claim 11
further comprising a plurality of kinds of printing drums which conform to respective lengths of a plurality of stencils and around which stencils conforming to the respective printing drums in length are wound,
wherein the second storage means comprises a plurality of storage portions each of which is provided on each of the printing drums to store the length of the stencil to be wound around the printing drum, and
the residue calculating means reads out the lengths of the stencils which have been made by reading out length of the stencil stored by the storage portion provided on the printing drum around which the stencil which has been made is wound.

16. A stencil making system as defined in claim 10 further comprising a display means which displays the number of stencils which can be further made on the basis of the stencil material roll residue calculated by the residue calculating means.

17. A stencil making system as defined in claim 10 in which said first storage means and/or the second storage means comprises a memory IC.

18. A stencil material roll, for carrying out a method of calculating a stencil material roll residue for use in a stencil making system where stencil material unrolled from a stencil material roll is perforated and cut to make a plurality of kinds of stencils having different lengths, the method comprising the steps of storing a total length of the stencil material roll before use and lengths of a plurality of kinds of stencils which the stencil making system can make and subtracting a length of the stencil made selected from the lengths of the plurality of kinds of stencils stored from the total length of the stencil material roll, comprising a storage means which stores a total length of the stencil material roll before use.

19. A stencil material roll as defined in claim 18 in which the storage means stores a stencil material roll residue which is obtained by cumulatively subtracting the lengths of the stencils which have been made from the total length of the stencil material roll.

20. A stencil material roll as defined in claim 18 in which the storage means stores the sum of the lengths of the stencils which have been made, to be cumulatively subtracted from the total length of the stencil material roll.

21. A stencil material roll as defined in claim 18 in which said storage means comprises a memory IC.
